(19) United States
(12) Patent Application Publication
(10) Pub. No.: US 2026/0245337 A1
(43) Pub. Date: Aug. 20, 2026

(54) A METHOD FOR PLACE RECOGNITION ON 3D POINT CLOUD

(71) Applicant: The University of Hong Kong, Hong Kong (CN)

(72) Inventors: Fu ZHANG, Hong Kong (CN); Chongjian YUAN, Hong Kong (CN)

(73) Assignee: The University of Hong Kong, Hong Kong (CN)

(21) Appl. No.: 18/995,126

(22) PCT Filed: Aug. 24, 2023
(86) PCT No.: PCT/CN2023/114553

§ 371 Date: Jan. 15, 2025

Related U.S. Application Data
(60) Provisional application No. 63/373,602, filed on Aug. 26, 2022.

(51) Int. Cl. G06V 10/46; G06T 7/50

(52) U.S. Cl. CPC G06V 10/462; G06T 7/50

(57) ABSTRACT

A key point extraction method and apparatus operate by taking in one or more point clouds and extracting one or more planes contained in each respective point cloud. One or more boundaries of each respective plane is identified if such boundaries of each respective plane are present in the respective point cloud. Then one or more nearby points are identify. Then the one or more points near each respective boundary is projected on to the respective plane to form a set of projected nearby points. An image is constructed based on the one or more projected points by mapping the set of projected nearby points to a set of pixels. Finally, one or more salient pixels are extracted from each respective image as one or more key points.

### CROSS-REFERENCE TO RELATED PATENT APPLICATIONS

This application is a U.S. National Stage Application under 35 U.S.C. § 371 of International Patent Application No. PCT/CN2023/114553, filed Aug. 24, 2023, and claims the benefit of priority under 35 U.S.C. Section 119(e) of U.S. Application No. 63/373,602, filed Aug. 26, 2022, all of which are incorporated herein by reference in their entireties. The International Application was published on Feb. 29, 2024 as International Publication No. WO 2024/041585 A1.

### FIELD OF THE INVENTION

The present invention relates to 3D point clouds and, more particularly to the determination of the location of a particular point in the cloud.

### BACKGROUND OF THE INVENTION

Place recognition on a 3D point cloud refers to the problem of detecting whether two 3D point clouds (e.g., a collection of points measured by range sensors) are measuring the same scene. It is a fundamental problem in many robotic techniques and applications that have increasingly been using ranging sensors (e.g., LiDARs, laser scanners, etc.). For example, in simultaneous localization and mapping (SLAM), place or location recognition allows from the detection of loops (e.g., where a robot re-visits a previous location) which effectively eliminates accumulated drift and produces high-quality, consistent 3D maps reconstructed from environments. Place recognition is also necessary to localize a new scan of sensor measurements (and hence, the sensor pose) against a prior map. These robotic technologies are the backbone of a variety of existing and emerging applications, such as drone navigation, autonomous driving, augmented/virtual reality (AR/VR), and 3D surveying and mapping.

In industry many technological companies and many autonomous driving startups, in industries such as automobile OEMs and mobile mapping, are pursing the place recognition problem, which is a fundamental problem in many technologies and applications (e.g., robot navigation, autonomous driving, AR/VR).

### BRIEF SUMMARY OF THE INVENTION

Embodiments of the subject invention provide four elements: (1) a method for key point extraction; (2) a new method for building a local descriptor; (3) a new global descriptor (i.e., a stable triangle descriptor); and (4) systems and methods to advantageously apply these elements in a place recognition problem.

Embodiments of the subject invention provide a new method for key point extraction, a new method for building local descriptors, a new global descriptor (e.g., stable triangle descriptor), and systems and methods to use these elements in place recognition problems.

Embodiments define a hierarchy among local, global, polygon, and stable triangle descriptors, with a local descriptor distinct from a global descriptor at the top level of the hierarchy; and within the global descriptor hierarchy, a related art polygon descriptor is distinct from a stable triangle descriptor. A local descriptor describes the shape geometry of a certain point (e.g., key points) in the point cloud. The local descriptor is distinguished from a global descriptor that describes the overall appearance of the point cloud as a whole. A polygon descriptor in related arts and the stable triangle descriptor embodiments provided by the subject invention are two different types of global descriptor. The term, stable triangle descriptor, is applied to elements of certain embodiments because the descriptors consist of one or more triangles and are stable with respect to pose invariance.

Embodiments of the stable triangle descriptor have advantages over related art methods referencing a polygon with four or more sides. Since the triangle is the most stable polygon, when the length of the three sides is determined, the shape of the triangle is uniquely determined. Other polygons do not have this uniqueness. For example, given the length of the sides of a quadrilateral, the shape can be stretched or compressed, resulting in an unfixed shape. Stable triangle descriptors are therefore advantageously distinguished from related art descriptors and methods referencing general polygons. Stable triangle descriptors are further advantageously distinguished from related art descriptors (e.g., “non-stable” triangle descriptors) and from data structures and methods referencing polygons of n=3 sides as follows: (1) Embodiments of the stable triangle descriptor also contain the projection direction information at each vertex (e.g., see Algorithm 1 below). The Angle between two vectors is invariant to pose. Therefore, the angle between the projection directions of adjacent vertices of a single stable triangle descriptor is helpful in further enhancing the uniqueness of the stable triangle descriptor when compared with other (e.g., related art or “unstable”) triangle descriptors. (2) In certain embodiments, each vertex of the stable triangle descriptor is a local descriptor, which contains the local point cloud information (distribution of point clouds) in the projection direction of the point. This is one area where certain embodiments of stable triangle descriptors differ most from other (e.g., related art, “non-stable”) triangle descriptors. In certain embodiments, for example, the successful matching of a pair of stable triangle descriptors not only means that the positions at the triangle vertices correspond to each other, but also means that the distribution of point clouds in the projection direction of the triangle vertices is similar, which improves the ability for place recognition. The stable triangle descriptors can remove a substantial number of incorrect or false matches during matching, which improves the efficiency and accuracy of scene recognition, while other triangle descriptors suffer from redundancy and incorrect triangle matching.

Existing work on place recognition in 3D data can be divided into three categories according to their principles: (i) local descriptor of key points features (e.g., [1, 2]), (ii) global descriptor (e.g., [3,4]), and (iii) a learning-based method (e.g., [5,6].). In (i) local descriptor of key points features, a local descriptor of a key point is a description of the shape geometries around the point. Based on the local descriptor, key points across different point clouds can be compared and matched. Then, from the number of key points successfully matched between the two point clouds, a place recognition can be asserted. In (ii) global descriptor (e.g., [3,4]), a global descriptor describes the point cloud as a whole, rather than describing the local shape geometry of each key point contained in the point cloud (like a local descriptor does). If two point clouds have similar global descriptors, a place recognition can be asserted. In (iii) a learning-based method (e.g., [5,6].) place recognition is performed similar to the local or global descriptor methods, except that the descriptors are learned from actual data by training a neural network, while in the local or global descriptor methods, the descriptors are computed directly.

Related art methods in the first category ((i) local descriptor of key points features, e.g., [1,2]) have a flow path as follows: key points extraction, building of local descriptors for each key point, and comparison of descriptor similarities across two point-clouds. Embodiments of the present invention use a similar flow path but differ from related art methods in the extraction of both key points and local descriptors. Specifically, for the key point extraction, related art methods [1] typically transform a 3D scan into a range image and extract point features from the range image. Such methods require the point cloud in a 3D scan to be very dense, which limits their use in a wider range of sensors. In contrast, embodiments of the present invention can advantageously extract points directly from the 3D space and accumulate multiple 3D scans into a denser point cloud for more reliable point extraction. For the local descriptor building, related art methods (e.g., [1,2]) extract the local descriptor of a key point based on its neighboring points in a small neighborhood. For example, the local descriptor extraction algorithm in [1] operates in two phases: first, the authors fit a plane using points around the key point; then, these neighboring points are projected to the fitted plane to obtain a 2D image, which is encoded into a vector that is the local descriptor. These local descriptors are very sensitive to the density and noise of the 3D point cloud because the point noise is significant when compared to the small neighborhood being used. In contrast, embodiments of the present invention can provide a local descriptor that does not depend on the point density and is also more robust with respect to point noises due to the large local space advantageously used. Moreover, the existing local descriptor in related art systems and methods is much less descriptive due to the small neighborhood being used. Thus, it is more likely to find more key points at different locations with very similar local descriptors. The lack of descriptiveness leads to many false point matches which severely affects the robustness of the place recognition. In contrast, embodiments of the present invention provide a local descriptor that uses a large local space above a key point, and therefore provide an extracted descriptor that is more descriptive.

Related art systems and methods of the second category ((ii) global descriptor e.g., [3, 4]) can summarize the overall appearance of the scene by extracting only a global descriptor of the point cloud. Compared with the local descriptors, the global descriptor does not extract descriptors of certain points (i.e., key points) in the point cloud, but instead uses the descriptors to describe the overall appearance of the point cloud as a whole. Therefore, the global descriptor has diminished sensitivity to local changes in the point cloud. For example, the method described in article [3] divides the point cloud into overlapping grids, then computes the shape properties of each cell by normal distribution transform and encodes each respective cell property into a histogram. Place recognition is then done by comparing the similarity among the histograms. The method described in article [4] uses a 2D descriptor based on the height of the surrounding structures to perform place recognition. The method described in article [5] uses a polygon descriptor to achieve place recognition in a forest environment.

Although embodiments of the subject invention provide a global descriptor that also summarizes the scene appearance, in contrast to related art systems and methods, it is substantially different in how it describes the scene appearance (how it extracts the global descriptors). For one thing, embodiments provide a global descriptor (i.e., stable triangle descriptor) that is totally invariant to the sensor poses, while related methods do not possess such invariance, and are thus dependent on sensor pose. That is, when the same scene is measured from one or more different sensor poses, related art descriptors can differ significantly to match with the library, leading to a very low recall rate (e.g., see the experimental results in FIGS. 10A-10D). Specifically, the method described in articles [3] and [4] can only achieve rotation invariance and the method described in article [5] is only invariant for (x, y, yaw) since the method therein compresses the landmark position data into 2D data. In addition to invariance, the advantage of the method of the present invention over other related art global descriptor methods is that embodiments of the subject invention do not require any assumptions based on the sensor location. The method in article [4] needs to assume that the sensor is being placed on the ground and changes its orientation, but not tilt. These factors limit the applicable scenarios for sensor pose dependent related prior art methods.

The third category of related art systems and methods ((iii) learning based methods, e.g., [6], [7] and [8]) introduce a deep neural network into the place or location recognition task, but these learning-based approaches require a large amount of training data (and training time) and rely on GPU processing, which is not convenient in practical applications. Compared with these methods, embodiments of the method of the present invention are more efficient and practical. Certain embodiments of the subject invention do not require any training data nor rely on any prior assumptions with regards to the sensors or scenes. All these make embodiments of the present invention very adaptable to a multitude of range sensors, environments, and applications.

Embodiments of the present invention provide an effective method to achieve robust, accurate, and data efficient place recognition on 3D point clouds. Experiments show that this method outperforms related prior art methods by more than 10% in terms of accuracy and recall rate, even in the types of urban road environments for which related prior arts systems and methods are specifically designed. In addition, embodiments of the methods of the present invention are more adaptable than related prior art methods since such embodiments of the present invention perform well (e.g., detecting more than half of the loop nodes) in an unstructured environment (e.g., where structural buildings such as floors and walls account for less than 30% of the environment) and effectively use different types of LiDAR devices to which related prior art methods cannot be efficiently adapted.

Embodiments of the subject invention address the technical problem of performing place recognition on two or more 3D point clouds (e.g., for detecting if two 3D point cloud are measured from the same scene) being inaccurate, inefficient, and unreliable. This problem is addressed by providing novel structures and methods to extract key points, local descriptors, and global descriptors that summarize the local and global appearance of a point cloud, and by providing systems and methods using the provided descriptors to perform place recognition more accurately, more efficiently, and more reliably as compared to related art systems and methods.

Embodiments can take a raw dense point cloud and extract reliable key points that constitute the provided descriptor. For low-resolution sensors, embodiments can allow the sensor measurements to accumulate for a certain period such that the point cloud is sufficiently dense to extract reliable feature points and both local and global descriptors. In certain embodiments the accumulation can be provided by accumulating past points in a sliding fashion, optionally using more sophisticated feature points extraction algorithms.

### BRIEF DESCRIPTION OF THE DRAWINGS

The file of this patent contains at least one drawing executed in color. Copies of this patent with color drawing(s)/photograph(s) will be provided by the Office upon request and payment of the necessary fee.

The foregoing and other objects and advantages of the present invention will become more apparent when considered in connection with the following detailed description and appended drawings in which like designations denote like elements in the various views, and wherein:

FIGS. 1A-1D provide a comparison of points contained in the current frame only and accumulated over a certain period, according to an embodiment of the subject invention, wherein the point cloud in FIG. 1A is obtained from a single frame of a multi-line spinning LiDAR, the point cloud in FIG. 1B is obtained from an accumulated frame of a multi-line spinning LiDAR, the point cloud in FIG. 1C is obtained from a single frame of a solid-state LiDAR, and the point cloud in FIG. 1D is obtained from an accumulated frame of a solid-state LiDAR;

FIG. 2 illustrates a process of plane fitting in a voxel, according to an embodiment of the subject invention;

FIGS. 3A-3B illustrate a process of plane expansion according to an embodiment of the subject invention, where in FIG. 3A the plane selected for expansion (green points) is indicated with four directional arrows (yellow arrows) and in FIG. 3B the plane has been expanded according to an embodiment of the subject invention;

FIGS. 4A-4C illustrate a process wherein the point cloud elements in the boundary voxels are projected onto the adjacent planes, according to an embodiment of the subject invention, wherein FIG. 4A shows points on an expanded plane in green, with adjacent boundary voxel points in yellow, with Detail 4B indicated by a white rectangle, in FIG. 4B the yellow boundary voxel points are projected onto the plane, as indicated by the red arrows, and in FIG. 4C a numerical overlay indicates the results of a pixel descriptor conversion process (e.g., as illustrated in FIG. 5) with numerical values indicating a descriptive value related to one or more pixels, and wherein in this embodiment, the number of layers above that pixel containing any points in the point cloud is shown and numbers that are maximum in a certain local region are considered key points and marked with a red circle;

FIG. 5 illustrates a process to convert height information into pixel descriptors, according to an embodiment of the subject invention, wherein certain embodiments can divide the space 0.2 m-2 m above a pixel into 18 layers and each layer is 0.1 m, whereby correspondingly, a pixel descriptor can have 18 bits, a bit is set to one if the corresponding layer has any points in the point cloud, otherwise the bit is zero and finally, all bits with ones are summed up to produce the pixel value (e.g., a number between 0 and 18);

FIG. 6 illustrates a set of key points extraction results (e.g., the red points in the figure), according to an embodiment of the subject invention;

FIG. 7 illustrates a standard stable triangle descriptor, according to an embodiment of the subject invention, where the vertices are arranged according to the side length: l₁₂<l₂₃<l₁₃;

FIGS. 8A-8C illustrate a place recognition case descriptor, according to an embodiment of the subject invention, and using the stable triangle descriptors of FIG. 7, where the stable triangle descriptors are in the two-point clouds S1 (FIG. 8A) and S2 (FIG. 8B) and the matching result of S1 and S2 is shown in FIG. 8C;

FIG. 9 illustrates an overview of the place recognition task, according to an embodiment of the subject invention;

FIGS. 10A-10D graphically represent precision-recall evaluation on a KITTI dataset, compared to precision-recall evaluation according to an embodiment of the subject invention using the Stable Triangle Descriptor (STD), showing the sequence KITTI0 (FIG. 10A), the sequence KITTI02 (FIG. 10B), the sequence KITTI05 (FIG. 10C), and the sequence KITTI08 (FIG. 10D);

FIG. 11 illustrates a place recognition task in a park environment, according to an embodiment of the subject invention, where the paths in the white box are the loop nodes;

FIG. 12 illustrates a place recognition task in a mountain environment, according to an embodiment of the subject invention;

FIGS. 13A-13D graphically represent precision-recall evaluation on data sets for park environments 1 (FIG. 13A) and 2 (FIG. 13B) as well as mountain environments 1 (FIG. 13C) and 2 (FIG. 13D), respectively, according to an embodiment of the subject invention using the Stable Triangle Descriptor (STD);

FIG. 14 illustrates plane detection using voxelization, according to an embodiment of the subject invention;

FIG. 15 illustrates the generation of three reference planes, according to an embodiment of the subject invention;

FIG. 16 illustrates height information encoding, according to an embodiment of the subject invention; and

FIG. 17 illustrates a series of processes related to key point extraction, according to an embodiment of the subject invention.

### DETAILED DESCRIPTION OF THE INVENTION

Certain embodiments of the subject invention comprise, consist of, or consist essentially of a method having three steps: key point extraction, global descriptor construction, and place detection.

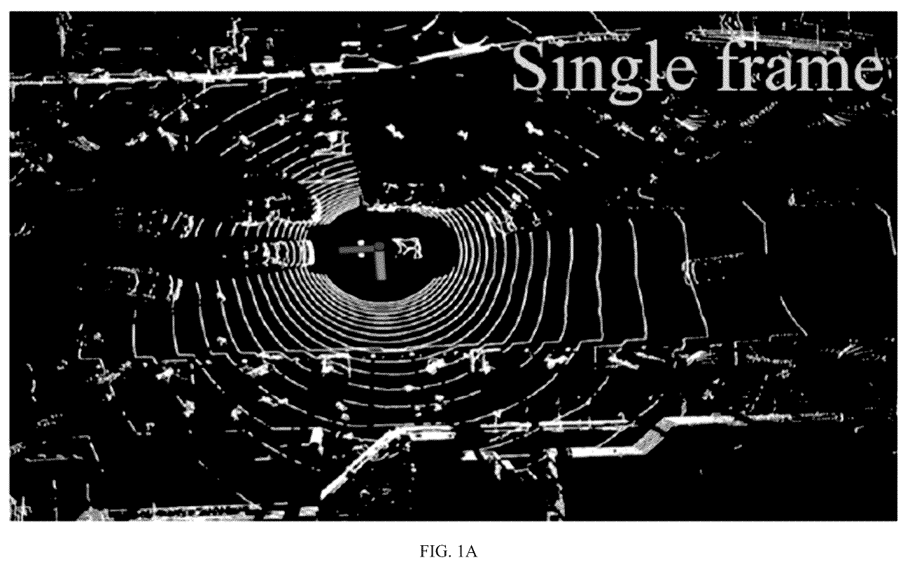

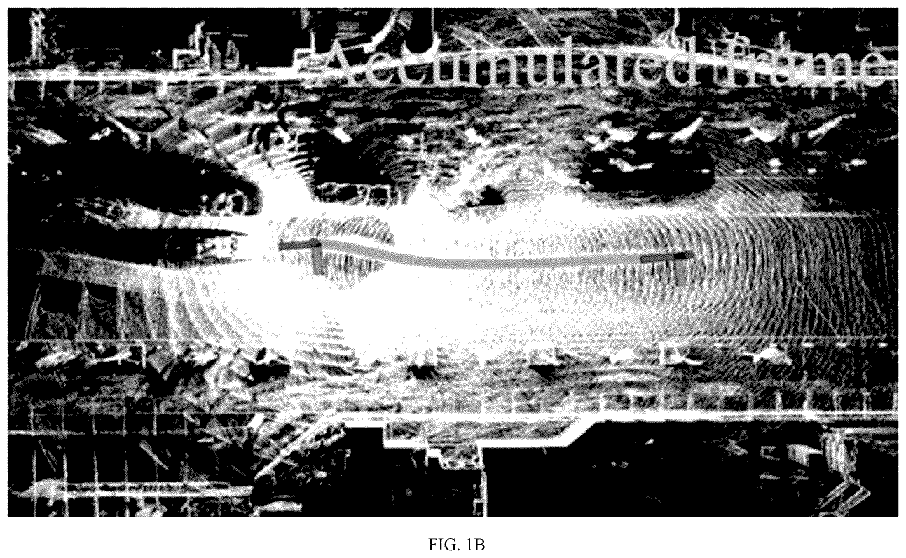

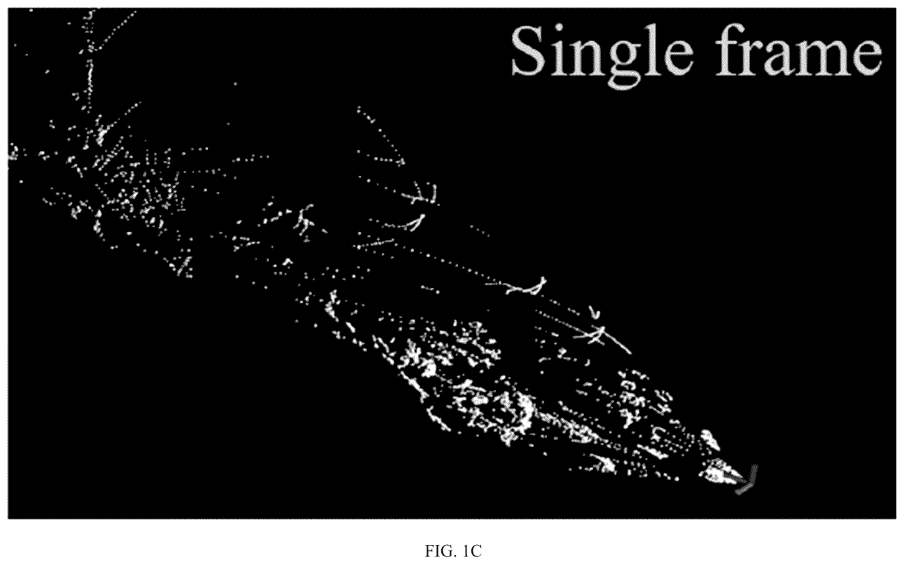

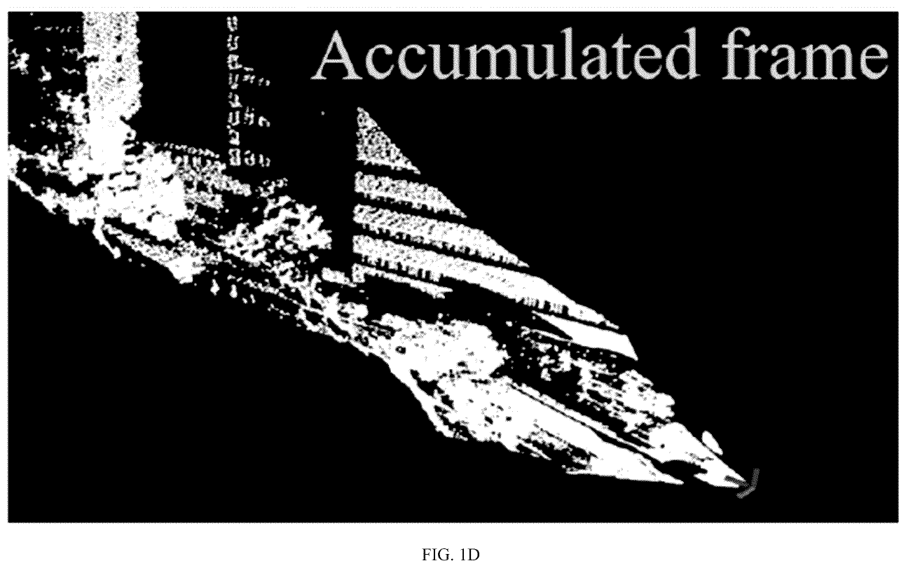

In the first step, embodiments can extract salient points (referred to as key points) and their local descriptors from the point cloud. The point cloud in FIG. 1A is obtained from a single frame of a multi-line spinning LiDAR. The salient points can be measured at the current time by the sensor or accumulated over a certain period (e.g., with odometry or other sensor localization input if the sensor is moving, see FIG. 1B, see also [9]).

Salient points can be extracted with known methods (e.g., see [10].) One novel method provided in certain embodiments of the subject invention is to project points to nearby planes, and then extract the projected points on corners when viewed within the plane. The detailed procedure is as follows:

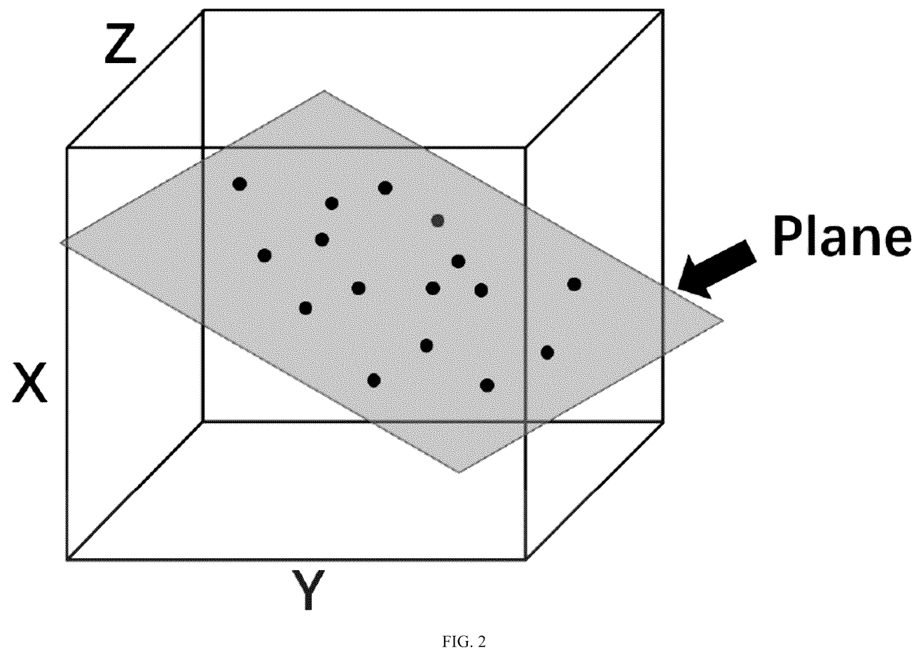

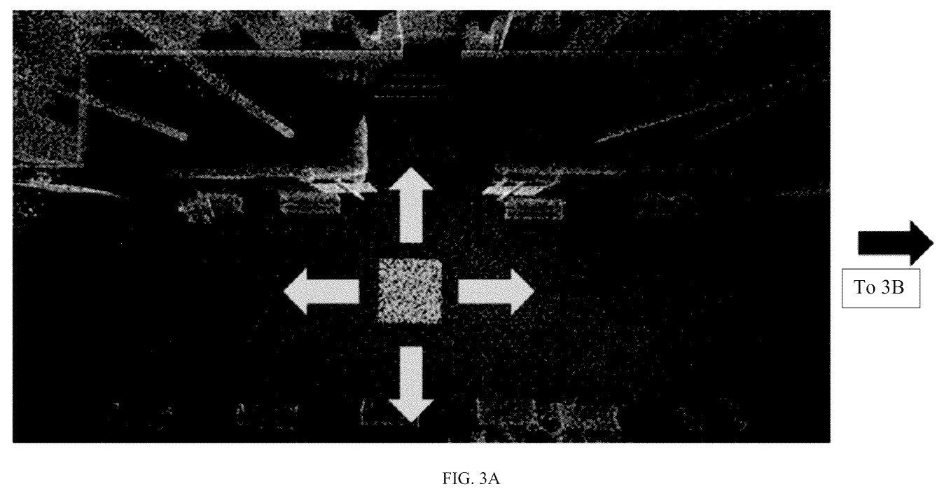

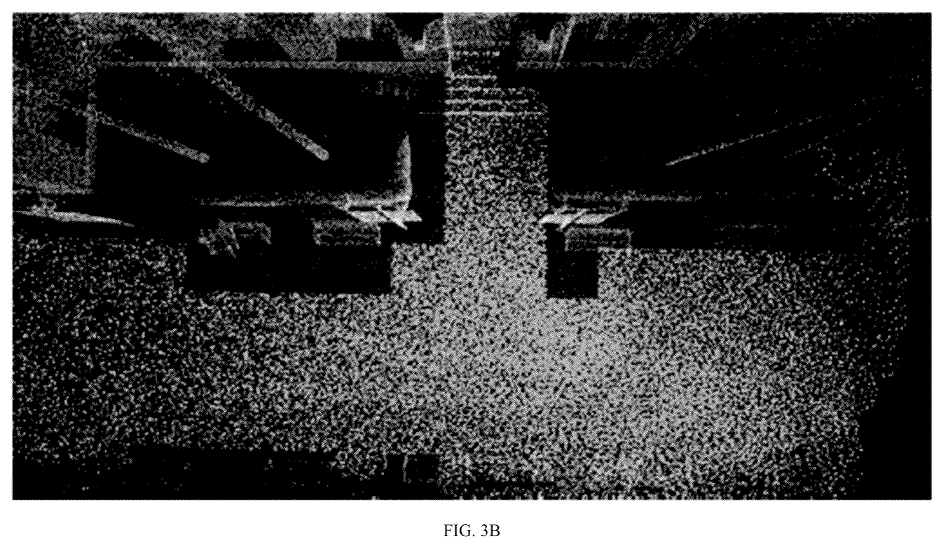

When given a point cloud, the first step according to the present invention is to perform plane detection by region growing. Specifically, the entire point cloud is divided into three-dimensional volume elements equivalent to a pixel in two-dimensional imaging (“voxels”), either with the same or different sizes between voxels, and a check is made to see if points within a voxel lie on a plane by fitting a plane to the contained points (e.g., see FIG. 2). If the summed residual distance from the contained points to the fitted plane is below a given threshold, the points in the voxel can be determined to lie on the plane. Then, a plane with any plane voxel is initialized and the plane is grown by searching for the nearby voxels. If the nearby voxels have points on the same plane (e.g., have the same plane normal direction within a specified tolerance), they can be added to the growing plane. Otherwise, if points in the nearby voxel do not lie on a plane nor on the same plane, that voxel is added to a list of boundary voxels. The above growing process can repeat until all the added voxels are expanded to reach the boundary voxels (e.g., see FIGS. 3A and 3B where the green area grows).

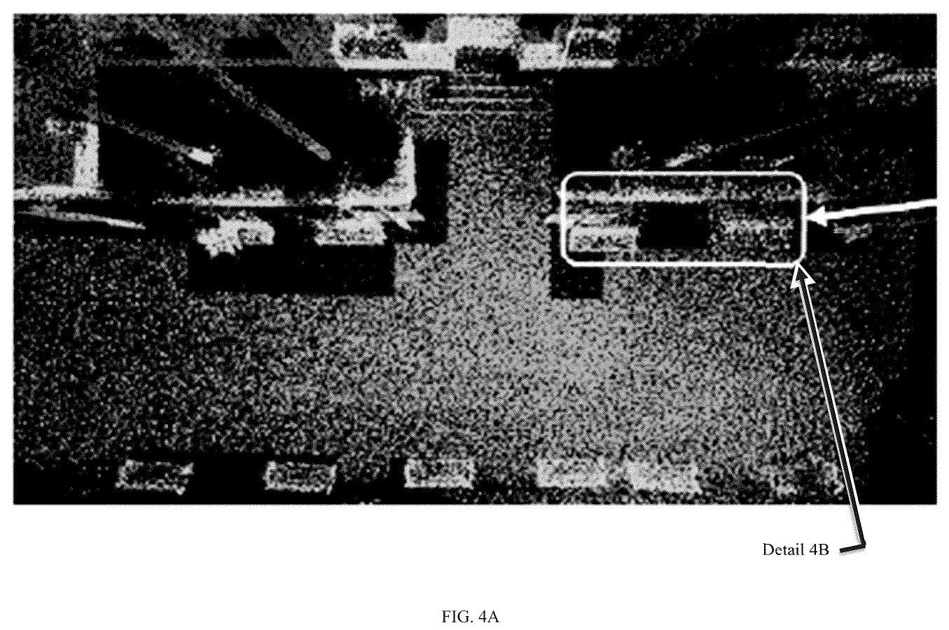

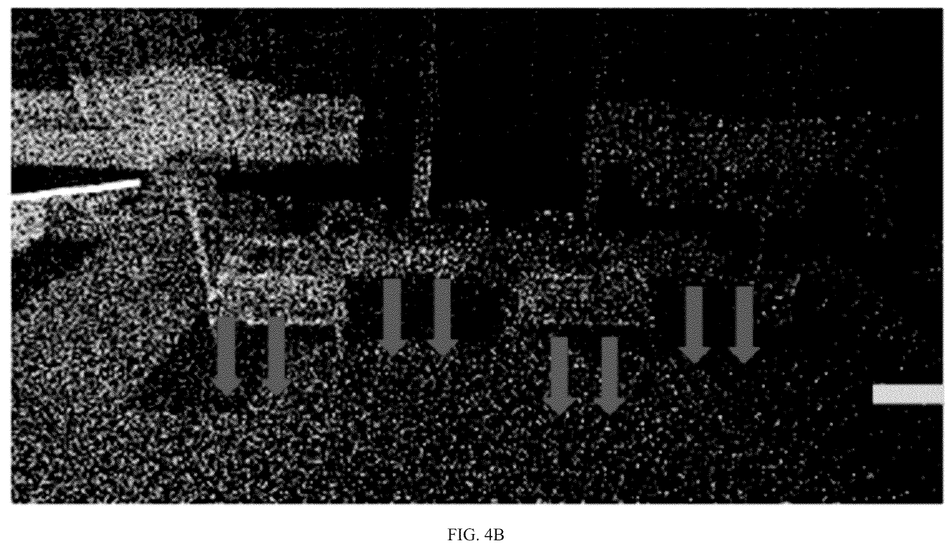

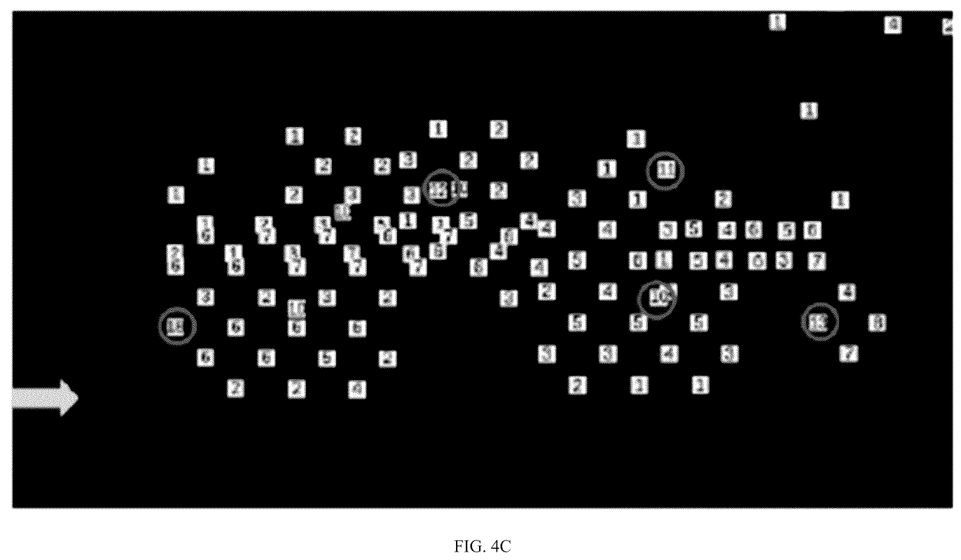

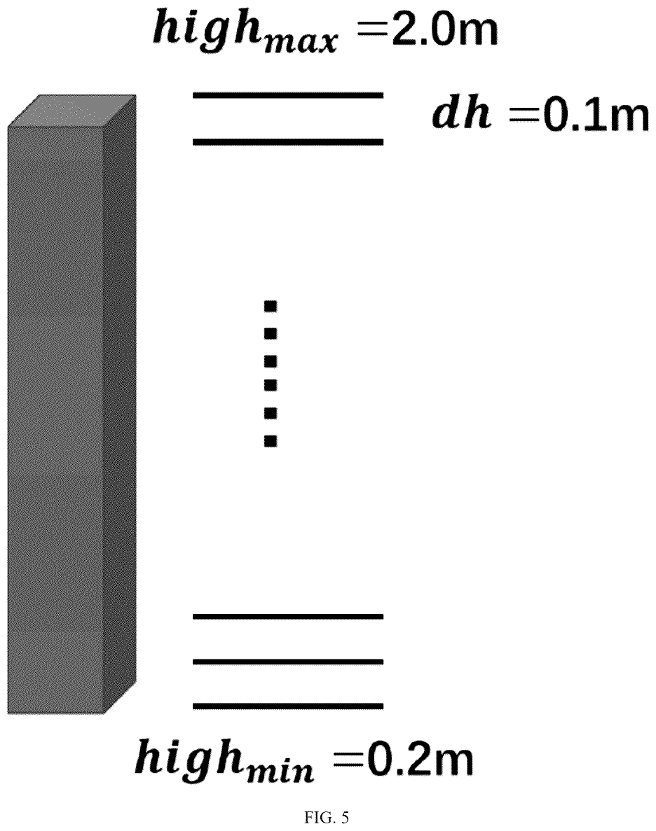

With respect to the boundary voxels, their contained points are projected to the respective plane (e.g., see FIG. 4B). Then the plane is taken as an image, where a pixel of a certain size saves the height information of the projected cloud (e.g., see FIG. 4C). Specifically, a certain height H above a pixel on the plane is selected and divided into N (N>=1) layers (e.g., see FIG. 5). Then a binary descriptor of N bits is constructed for the pixel, where a bit in the descriptor is set to one if the corresponding layer has any points in the point cloud, otherwise the bit is set to zero. The binary descriptor now constitutes the local descriptor for the pixel. Based on the binary descriptor a pixel value (e.g., the sum of the number of ones in the binary descriptor) is further computed, from which key points, such as corner pixels or a pixel with locally maximal pixel values, can be extracted from the image (e.g., see the red circles in FIG. 4C). Each extracted key point corresponds to a pixel in the plane, and can be attached to the normal of the plane and the local descriptor can be extracted, as in the preceding stages. Other information, such as reflectivity, can also be attached to the extracted key point. An exemplary detailed algorithm flow for key point extraction can be found in Algorithm 1.

Algorithm 1: Key point extraction

Input: 3D point cloud P_{c};

Voxel size S;
Plane judgement threshold σ

Output: Key points pᵢ(i = 1,2, ..., n)

| | |
|---|---|
| 1. | Divide the point cloud P_{c} into voxels with voxel size S, get voxel list Vₗ |
| 2. | for each voxel Vⱼ in the voxel list Vₗ do |
| 3. | Fit a plane πⱼ with points in the voxel Vⱼ |
| 4. | Calculate the mean point-to-plane distance dⱼ |
| 5. | if dⱼ < σ then |
| 6. | The points in the voxel are assumed (or determined) to lie on the same plane πⱼ. |
| 7. | Save the plane πⱼ into the plane list Πₗ with plane center qⱼ and normal vector nⱼ |
| 8. | end |
| 9. | end |
| 10. | for each plane πⱼ in the plane list Πₗ do |
| 11. | Locate the voxel containing the plane πⱼ, search the nearby voxels. |
| 12. | If Nearby voxel has the same plane, then |
| 13. | Merge the planes in the voxels. |
| 14. | else |
| 15. | Add the voxel to a list of boundary voxels. |
| 16. | end |
| 17. | end |
| 18. | for each voxel in the boundary voxels list do |
| 19. | Project the points in the voxel to the adjacent plane |
| 20. | Convert the projection plane into an image and assign the pixel value and local |
| | descriptor |
| 21. | Extract key points pᵢ in the image |
| 22. | Save all key points, their plane normal, and local descriptors |
| 23. | end |

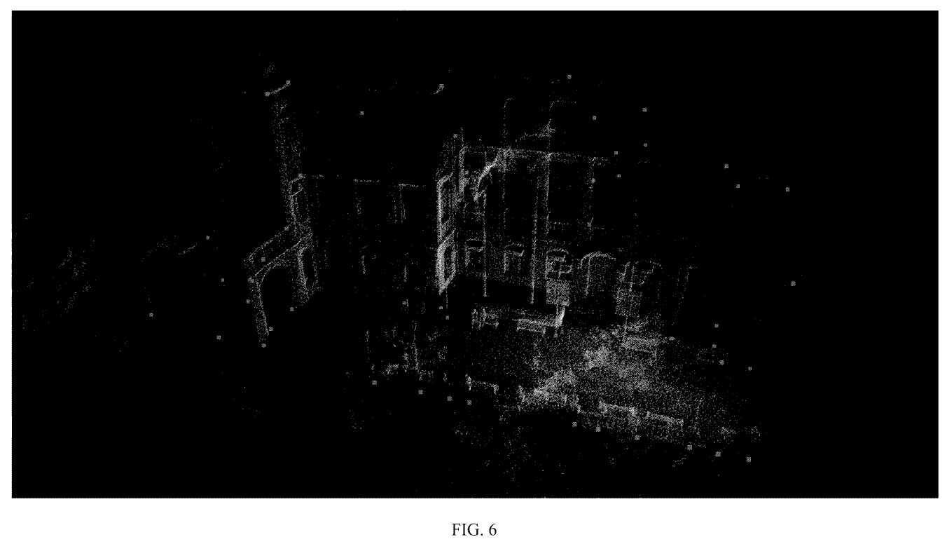

Embodiments of the invention can extract all planes (and the associated plane boundary and corner points) in the input point cloud and obtain a set of key points (e.g., see FIG. 6). The extracted key points are totally pose invariant. That is, regardless of the sensor viewpoint, the extracted plane, plane boundary and hence key points are found at the same location in the scene.

In contrast with the above method in which boundary voxels are projected onto adjacent planes for key point extraction, another novel method for key point extraction provided in certain embodiments of the present invention includes introducing a concept called a “reference plane” and projected all point clouds onto this reference plane for key point extraction. The detailed procedure is as follows:
1) Plane Detection: Similar to the description above, when given a point cloud submap, plane detection can be performed by first growing the region. A more specific example of the process of plane detection is described below:

First, the entire point cloud is divided into voxels of a given size ΔL (e.g., ΔL=1~2 m). Each voxel contains a group of points pᵢ(i=1 . . . , N). Then the point covariance matrix Σ can be calculated for each voxel:

$$\overline{p} = \frac{1}{N} {\sum }_{i = 1}^{N} {p}_{i} ; \sum = \frac{1}{N} {\sum }_{i = 1}^{N} ( {p}_{i} - \overline{p} ) {( {p}_{i} - \overline{p} )}^{T} ; \qquad ( equation 1 )$$

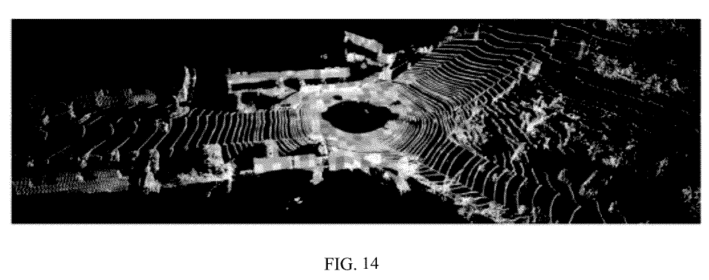

An eigenvalue decomposition of matrix Σ is performed to obtain its eigenvalues λ₁, λ₂, λ₃ (with λ₁≥λ₂≥λ₃) and corresponding eigenvectors u₁, u₂, u₃. Then the plane criterion is defined by two pre-set thresholds, σ₁ and σ₂, such that a voxel is classified as a plane if λ₃<σ₁ and λ₂>σ₂. A plane voxel is represented as π, which contains the plane normal vector u₃, center point p̅, number of points N, and point covariance matrix Σ. This criterion is applied to all voxels and a list of planes denoted by Π=(π1, π₂, . . . , πₖ) is obtained. FIG. 14 illustrates the plane detection result obtained through voxelization on the first submap of the KITTI00 dataset. The plane points are colored according to their voxel ID. These planes, encapsulating key geometric information of the scene, will be used for the following key point extraction.
2) Reference Plane Generation: Upon acquiring the list of planes Π, reference planes can be generated. This involves merging adjacent planes to yield larger planes. Specifically, the plane merging begins by selecting an initial plane voxel and progressively examining the planes in neighboring voxels. If the plane in neighboring voxels has a similar normal vector and a near-to-zero distance, it is merged with the initial plane. Specifically, if the initial plane voxel πᵢ and the neighboring plane voxel πⱼ have centers p̅ᵢ, p̅ⱼ, and normals u₃ᵢ, u₃ⱼ, the merging criteria is

$$\begin{matrix}max ( {u}_{3 i}^{T} ( {\overline{p}}_{i} - {\overline{p}}_{j} ) , {u}_{3 j}^{T} ( ( {\overline{p}}_{j} - {\overline{p}}_{i} ) ) ) \leq {σ}_{d} \\ arccos ( {u}_{3 i} \cdot {u}_{3 j} ) \leq {σ}_{u}\end{matrix} \qquad ( equation 2 )$$

where σ_{d}, σᵤ are two thresholds. The merged plane πₘ has a points number Nₘ, center point p̅ₘ and point covariance matrix Σₘ as follows:

$$\begin{matrix}{N}_{m} = {N}_{i} + {N}_{j} , {\overline{p}}_{m} = \frac{{N}_{i} {\overline{p}}_{i} + {N}_{j} {\overline{p}}_{j}}{{N}_{m}} , \\ {\sum }_{m} = \frac{{N}_{i} ( {\sum }_{i} + {\overline{p}}_{i} {\overline{p}}_{i}^{T} ) + {N}_{j} ( {\sum }_{j} + {\overline{p}}_{j} {\overline{p}}_{j}^{T} )}{{N}_{m}} - {\overline{p}}_{m} {\overline{p}}_{m}^{T}\end{matrix} \qquad ( equation 3 )$$

In addition, the normal vector uₘ of the merged plane is calculated through the eigenvalue decomposition of Σₘ. This merging process continues in a region-growing manner until neighboring voxels have no planes.

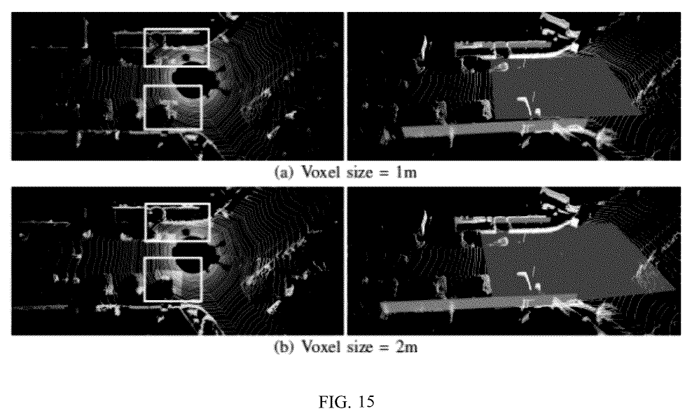

The merged planes can be sorted in descending order according to the number of contained points. Then, the first M planes with the most points are selected as reference planes. Most of the time, selecting one reference plane (M=1) is sufficient. In certain cases, characterized by uneven terrain (e.g., mountainous regions, urban environments with tall buildings, or areas with significant changes in elevation), the selection of two or more reference planes (M≥2) may be necessary to account for the complexity of the landscape. FIG. 15 shows the generation of three reference planes (i.e., M=3) in an urban environment. Specifically, FIG. 15 shows a comparison of all merged planes and the selected M (M=3) reference planes, at different voxel sizes, with portion (a) for voxel size=1 m and portion (b) for voxel size=2 m. The left subfigures show the results of all merged planes (colored by plane normals, whereas non-plane points are depicted in yellow), and the right subfigures display the selected M reference planes (with size determined by the largest and second largest eigenvalues of the covariance matrix Σₘ of the merged planes). As can be seen, despite the different voxel sizes, the selected or generated reference planes are the same.
3) Height-encode Image Generation: After obtaining the reference planes, the 3D point cloud is projected onto each reference plane, creating M height-encoded images with a pixel area r×r m². The choice of r is a trade-off between computational efficiency and the ability to capture sufficient detail in the height-encoded image.

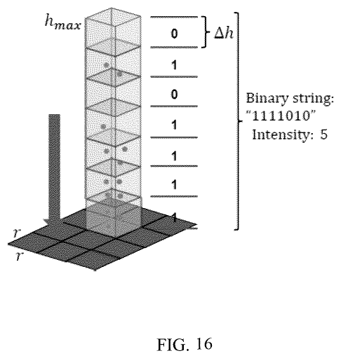

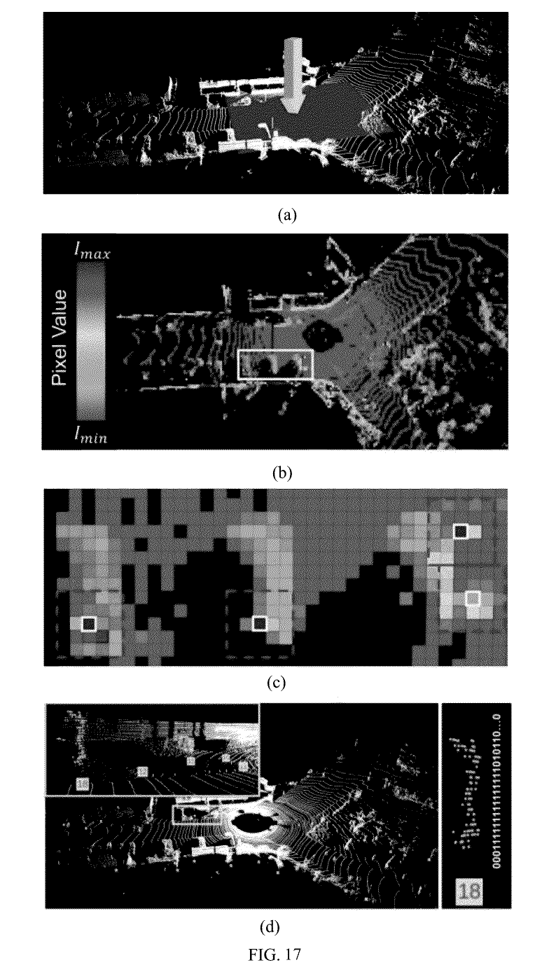

To encode the height information, as depicted in FIG. 16, a maximum height hₘₐₓ above each pixel on the plane is selected and divided into m layers with a fixed resolution Δh. For each pixel, a binary string b composed of m bits is computed, where each bit is set to one if the corresponding layer contains any points at this height range or else set to zero. Summing all the m bit values leads to the pixel intensity, which is saved to each pixel along with the binary string. A height-encoded image example is depicted in portion (b) of FIG. 17.
4) Key point Extraction: With the M height-encoded images in hand, key points on each image can be extracted, as demonstrated in portion (c) of FIG. 17. Key points are determined by identifying pixels with the maximum intensity in their local 5×5 area. These local maxima represent areas with high point populations, hence retaining the most information of the original 3D point cloud. To suppress the number of key points, a threshold σₗ on the local maximum intensity can be set. Only a pixel with the local maximum intensity above this threshold is selected as a key point. Once a key point is identified in the height-encoded image, its 3D coordinates within the submap can be determined. To do this, first, the point location on the reference plane is determined by averaging the 2D coordinates of all points above the pixel used for height encoding. This in-plane location is then used to calculate the full 3D location of the key point based on the plane parameter. By utilizing the average 2D coordinates of projected points rather than the pixel's center, sub-pixel conversion accuracy can be attained. Portion (d) of FIG. 17 illustrates the extracted key points (depicted as yellow squares) and the attached binary string.

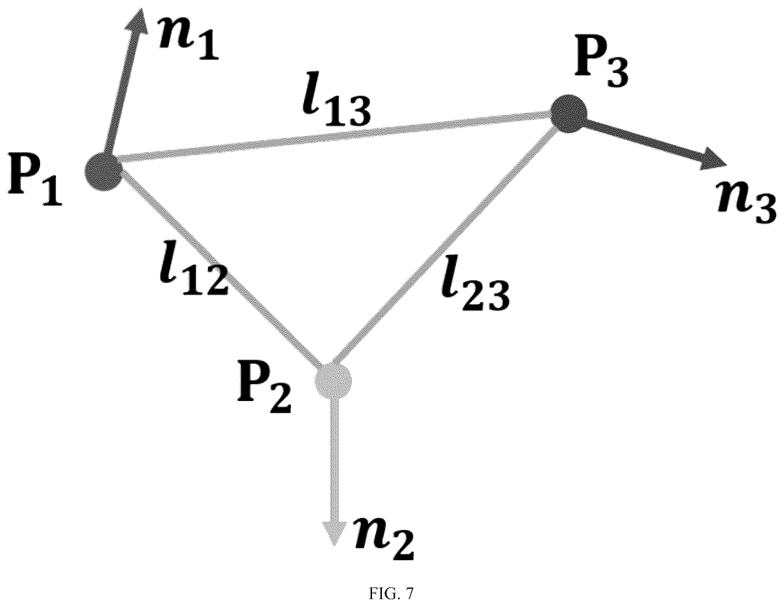

The second step builds the global descriptor. Embodiments provide a stable triangle descriptor, which takes any (or a selected set of) three points extracted in the first step and forms a standard triangle, where the vertices or sides are arranged in a prescribed order (e.g., the sides are in descending or ascending order, as shown in FIG. 7). In certain embodiments, the stable triangle descriptor consists of:
P₁, P₂, P₃: three selected key points as vertices
n₁, n₂, n₃: three normal vectors attached to the tree key points, respectively
l₁₂, l₂₃, l₁₃: length of three sides connecting the respective vertices
A₁, A₂, A₃: local descriptors and other information attached to each key point or extracted from them.
Centroid: the center of the triangle.

Alternative embodiments advantageously provide some or all of the elements listed above, and certain embodiments provide additional elements.

Embodiments of the invention can extract all (alternatively a subset or a selection of) stable triangle descriptors based on all (alternatively based on a subset or a selection of) key points contained in the point cloud. The extracted descriptors are saved to a library of an appropriate data structure (e.g., a Hash table or a kd-tree) for efficient inquiry by the place recognition module. When saving a global descriptor to the library, embodiments can use the pose-invariant attributes, including the sides length l₁₂, l₂₃, l₁₃, included angles between point normal n₁, n₂, n₃, and other local descriptors A₁, A₂, A₃ if applicable to calculate an index in (alternatively to order, structure, or otherwise optimize) the library.

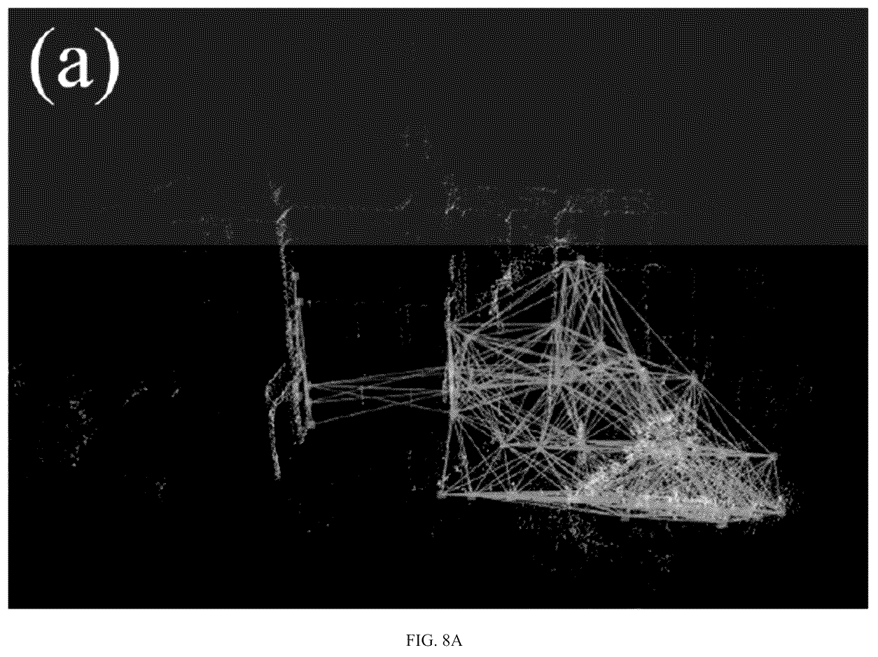

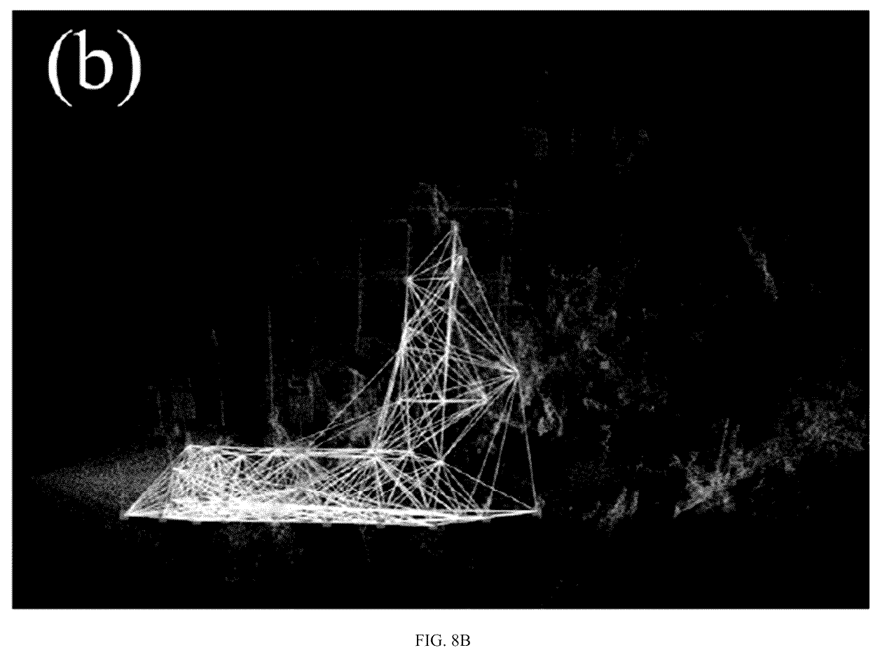

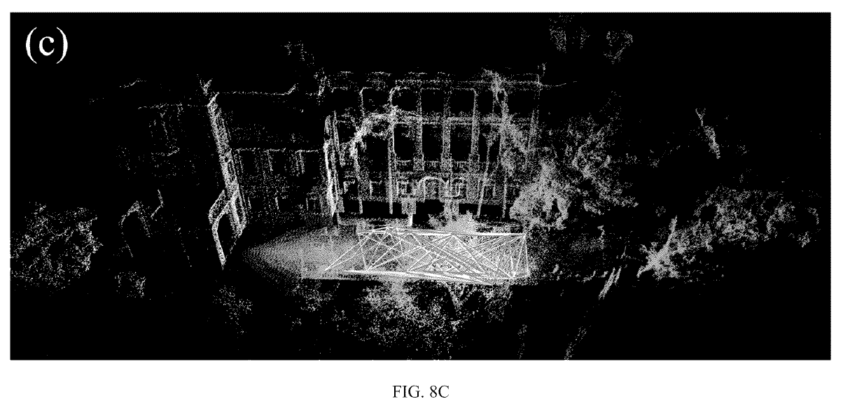

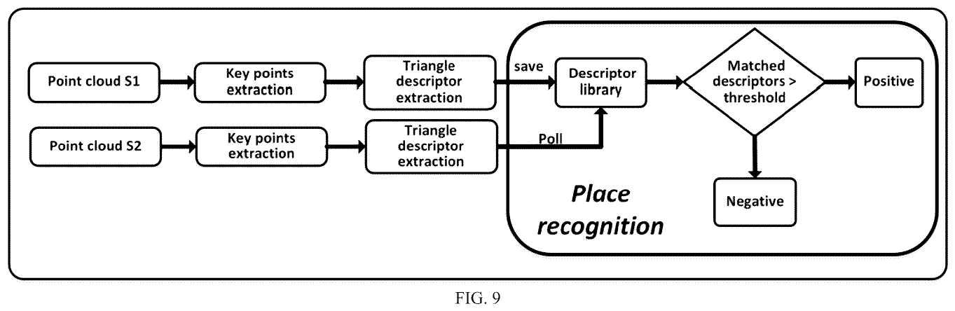

The third step comprises performing a place recognition. In this step, embodiments of the present invention extract the stable triangle descriptors in the two point clouds S1 (FIG. 8A) and S2 (FIG. 8B), save the stable triangle descriptor of one point cloud (e.g., S1) to the library and poll in the library each descriptor in the other point cloud (e.g., S2). If the matched descriptor exceeds a certain number (or ratio), the two point clouds are determined to be taken in the same scene. One additional benefit of the provided stable triangle descriptor is that, if a stable triangle descriptor is matched to another stable triangle descriptor in the library, their vertices (P₁, P₂, P₃) naturally match. This point correspondence can be advantageously used to reject false matches by examining their local descriptors or to compute the relative pose between the two point-clouds and reject false positive place detection using methods such as RANSAC [11]. The matching result of S1 and S2 is shown in FIG. 8C. An overview of the place recognition step can be seen in FIG. 9.

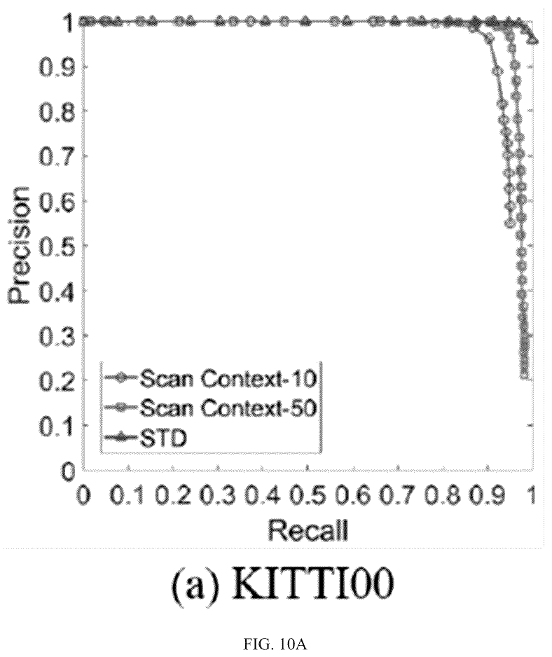

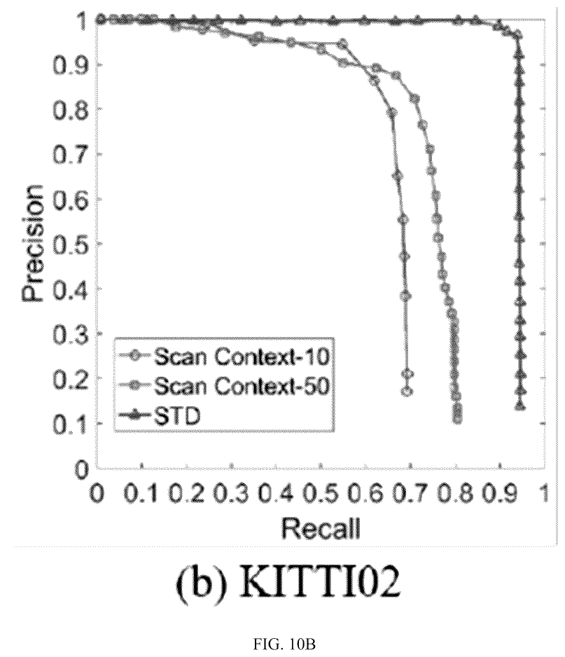

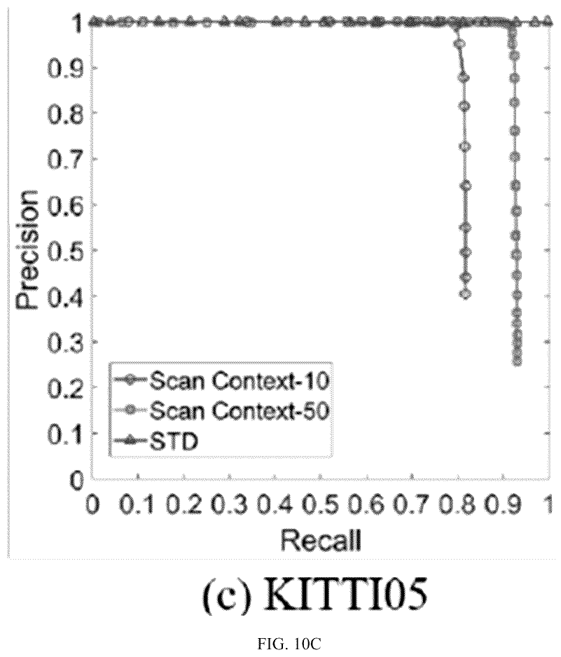

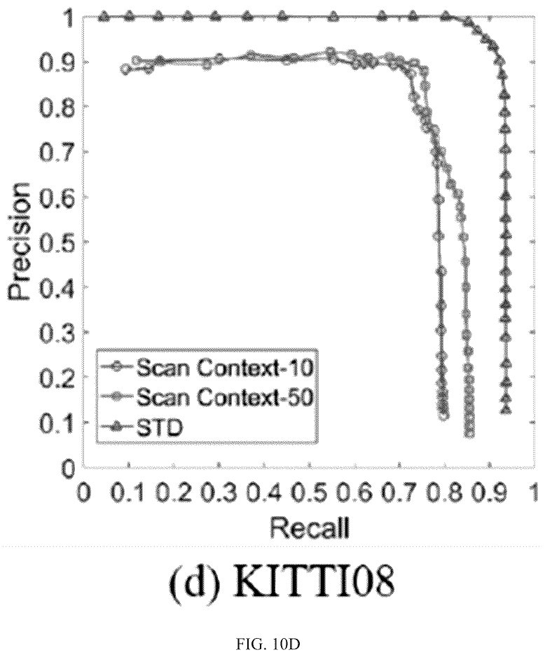

The performance of a method according to an embodiment of the subject invention was evaluated on one of the world's largest and most challenging SLAM datasets for autonomous driving in urban streets (i.e., the KITTI Odometry dataset) and compared with other related prior art methods, such as Scan Context [4]. The experiment for Scan Context was conducted with 10 candidates and 50 candidates from the databases, called Scan Context-10 and Scan Context-50, respectively. The evaluation results are shown in FIGS. 10A-10D. For quantitative evaluation, the Break-Event Point (BEP) can be used to compare the performance of STD with Scan Context-10 and Scan Context-50. BEP is the value when “Precision=Recall” in the PR curve in FIGS. 10A-10D. The higher the BEP, the higher the overall performance of the method. The results of BEP results are summarized in Table 1:

TABLE 1
The BEP result of STD, Scan Context-10 and Scan Context-50

| Data Id | KITTI00 | KITTI02 | KITTI05 | KITTI08 | Mean |
|---|---|---|---|---|---|
| STD | 0.96 | 0.92 | 1.00 | 0.91 | 0.95 |
| Scan | 0.85 | 0.65 | 0.80 | 0.74 | 0.76 |
| Context-10 | | | | | |
| Scan | 0.93 | 0.74 | 0.91 | 0.75 | 0.83 |
| Context-50 | | | | | |

It can be seen that the method of the present invention has higher accuracy in all sequences in terms of the BEP result.

A more comprehensive experimental evaluation has also been conducted. Specifically, various datasets were selected, including KITTI Odometry dataset, NCLT dataset, Wild-Places dataset, and Livox Dataset, to thoroughly evaluate the performance of the proposed methods under different conditions. The proposed methods are compared against four existing methods: Scan Context, M2DP, NDT, and BoW3D. The results show that the proposed methods of the present invention have advantages over existing methods in terms of average precisions (APs), total computation time and so on. The proposed methods are also compared against recent state-of the-art deep learning-based approaches, namely such as LCDNet and log 3D-Net, and the proposed methods also show significant advantages in terms of AP and computation time.

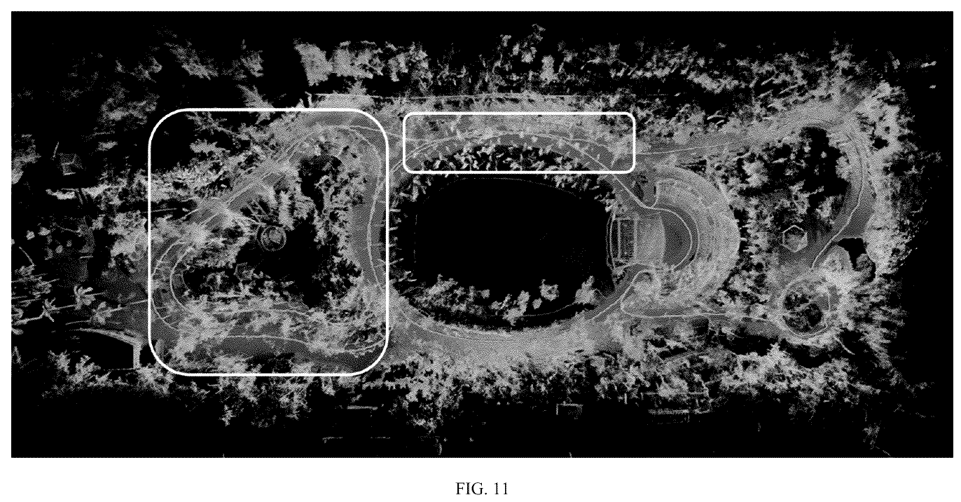

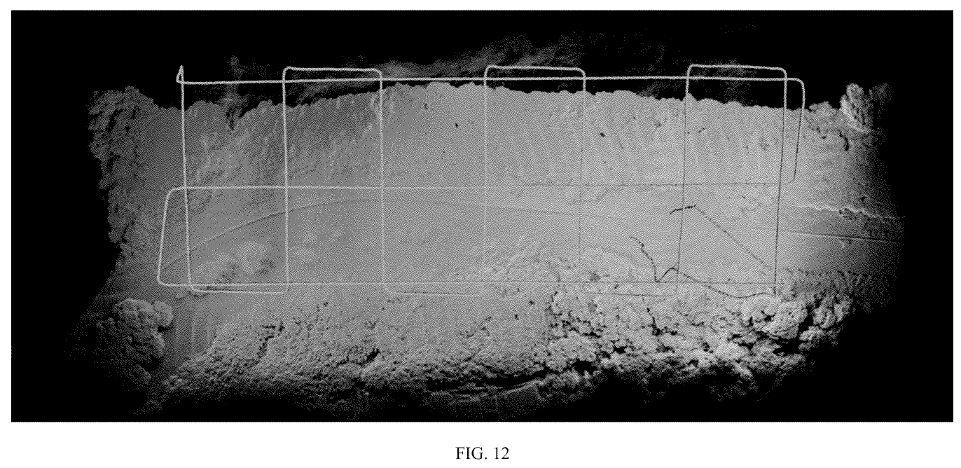

In order to verify the effectiveness of the provided method in more scenarios (e.g., terrestrial mapping and aerial surveying and mapping), the provided method was tested on data collected in a park environment (e.g., see FIG. 11) and on a drone (e.g., see FIG. 12) with Livox Avia LiDAR, a totally different LiDAR from the multi-line spinning LiDAR used in KITTI. The evaluation results are shown in FIGS. 11-13. It can be seen that in an unstructured environment (e.g., where structural buildings such as floors and walls account for less than 30% of the environment), the provided method can still work well with a mean BEP result of 0.67 in a park environment and a mean BEP result of 0.81 in a mountain environment.

Turning now to the figures, FIGS. 1A-1D provide a comparison of points contained in the current frame only and accumulated over a certain period, according to embodiments of the subject invention. In each frame a point cloud is represented by white points, sometimes appearing as lines, and either a single tri-colored axis, or a pair of axes connected by a cyan line represents collection frame or frames of reference. The accumulated frames show a greater density point cloud compared to the single frames. The point cloud in FIG. 1A is obtained from a single frame of a multi-line spinning LiDAR. The point cloud in FIG. 1B is obtained from an accumulated frame of a multi-line spinning LiDAR. The point cloud in FIG. 1C is obtained from a single frame of a solid-state LiDAR. The point cloud in FIG. 1D is obtained from an accumulated frame of a solid-state LiDAR.

FIG. 2 illustrates a process of plane fitting in a voxel, according to an embodiment of the subject invention. A (blue) plane is fit to (black dot) points within a voxel by methods known in the art.

FIGS. 3A-3B illustrate a process of plane expanding according to an embodiment of the subject invention. In FIG. 3A the plane selected for expansion (green points) is indicated with four directional arrows (yellow arrows.) In FIG. 3B the plane has been expanded and boundaries found according to an embodiment of the subject invention.

FIGS. 4A-4C illustrate a process wherein the point cloud elements in the boundary voxels are projected onto the adjacent planes, according to an embodiment of the subject invention. FIG. 4A shows points on an expanded plane in green, with adjacent boundary voxel points in yellow, with Detail 4B indicated by a white rectangle. In FIG. 4B the yellow boundary voxel points are projected onto the plane, as indicated by the red arrows. In FIG. 4C a numerical overlay indicates the results of a pixel descriptor conversion process (e.g., as illustrated in FIG. 5) with numerical values indicating a descriptive value related to one or more pixels. In this embodiment, the number of layers above that pixel containing any points in the point cloud is shown and numbers that are maximum in a specified local region are considered key points and marked with a red circle.

FIG. 5 illustrates a process to convert height information into pixel descriptors, according to an embodiment of the subject invention. Certain embodiments can divide the space 0.2 m-2 m above a pixel into 18 layers, in this non-limiting embodiment, each layer is 0.1 m high. Correspondingly, a pixel descriptor can have 18 bits, a bit can be set to one if the corresponding layer has any points in the point cloud, otherwise the bit can be zero. Finally, all bits with ones can be summed up to produce the pixel value (which in this embodiment, can be a number between 0 and 18).

FIG. 6 illustrates a set of key point extraction results (e.g., the red points in the figure), according to an embodiment of the subject invention.

FIG. 7 illustrates a standard stable triangle descriptor, according to an embodiment of the subject invention. Vertices can be arranged according to the side length (e.g., l₁₂<l₂₃<l₁₃).

FIGS. 8A-8C illustrate an example of place recognition using the stable triangle descriptors of FIG. 7, according to embodiments of the subject invention. FIG. 8A shows the stable triangle descriptors extracted from a query point cloud. FIG. 8B shows the stable triangle descriptors extracted from a library point cloud. FIG. 8C shows the matching results of the stable triangle descriptors according to an embodiment of the subject invention.

FIG. 9 illustrates a flow diagram of a place recognition task, according to an embodiment of the subject invention.

FIGS. 10A-10D graphically represent precision-recall evaluations on KITTI dataset, compared to precision-recall evaluations using the Stable Triangle Descriptor (STD), according to an embodiment of the subject invention. The upper curve in each graph (STD) is marked by a (purple) line with hollow triangular points. The lowest curve, Scan Context-10 in each graph, is marked by a (blue) line with hollow circular markers. The middle curve, Scan Context-50 in each graph, is marked by a(n) (orange) line with hollow square points. Quantitatively, the Break-Event Point (i.e., BEP, the value of precision when precision is equal to recall in the PR curve) for the STD, Scan Context-10, Scan Context-50 are 0.96, 0.85, 0.93, respectively, on the sequence KITTI0 (FIG. 10A), 0.92, 0.65, 0.74, respectively, on the sequence KITTI02 (FIG. 10B), 1.00, 0.80, 0.91, respectively, on the sequence KITTI05 (FIG. 10C), and 0.91, 0.74, 0.75, respectively, on the sequence KITTI08 (FIG. 10D). The overall mean BEP improvements of STD over Scan Conext-10 is more than 0.18 and over Scan Conext-50 is more than 0.11.

FIG. 11 illustrates a place recognition task in the park environment, according to an embodiment of the subject invention. The point cloud data were collected by a hand-held device. The color of the point cloud is determined by its height. The point cloud data were registered by A LiDAR-inertial odometer FAST-LIO2 [9]. The blue traces are the tracks of data acquisition. The path in the white boxes are the loop nodes, where the place recognition takes place.

FIG. 12 illustrates a place recognition task in the mountain environment, according to an embodiment of the subject invention. The point cloud data were collected by a UAV (unmanned aerial vehicle). The LiDAR is mounted on the UAV and faces the ground. The color of the point cloud is determined by its height. The point cloud data were registered by a LiDAR-inertial odometer FAST-LIO2 [9]. The blue traces are the tracks of data acquisition.

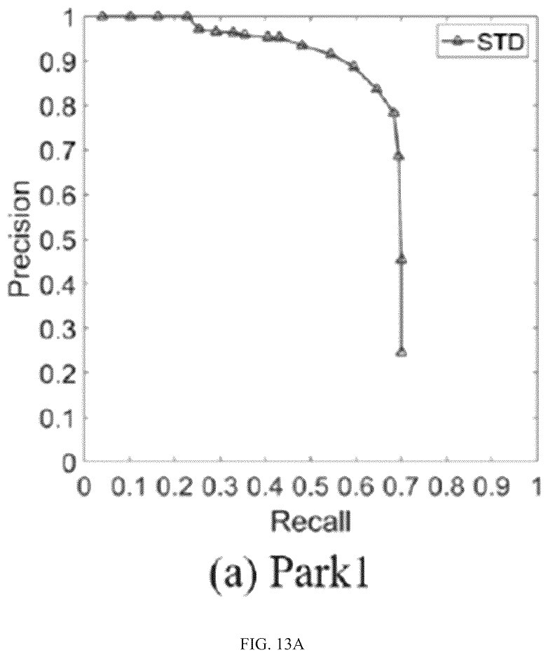

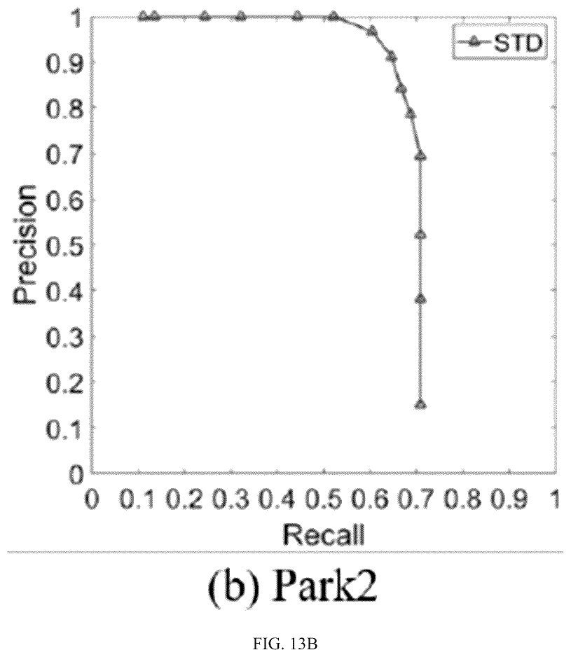

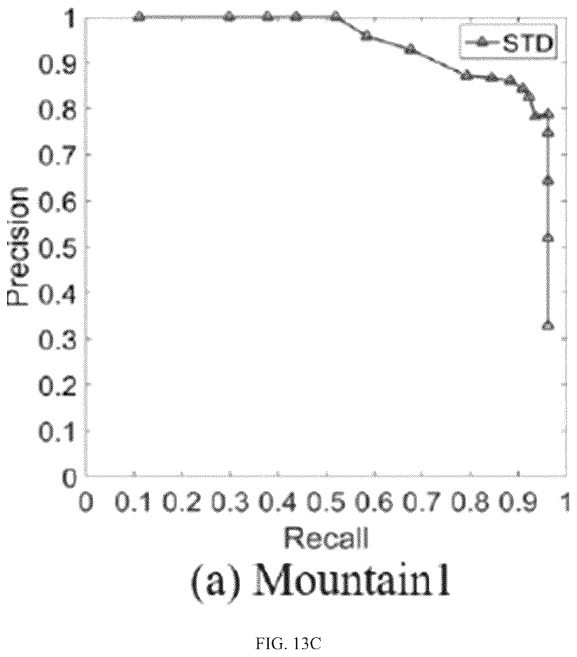

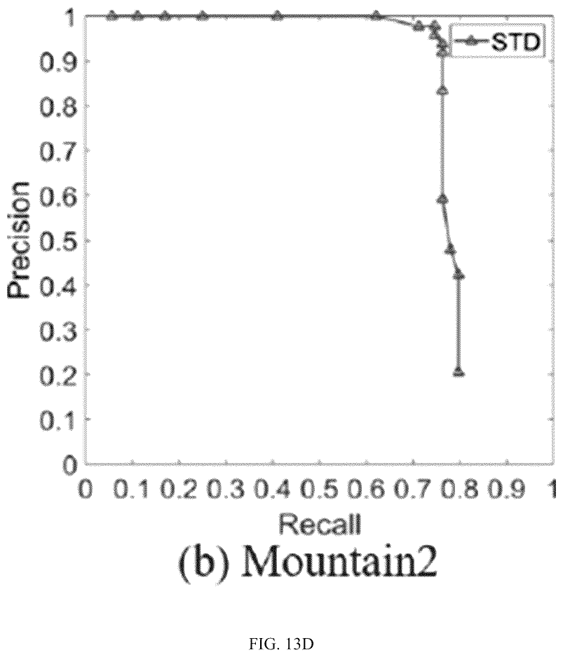

FIGS. 13A-13D graphically represent precision-recall evaluation on park environment and mountain environment datasets, respectively, according to an embodiment of the subject invention using the Stable Triangle Descriptor (STD). The mean Break-Event Point (the value of Precision when “Precision=Recall” in the PR curve) of STD in the park environment and mountain environment dataset are 0.67 and 0.81, respectively, which means STD can detect more than half of the loop nodes in these datasets. Other methods are rarely tested in an unstructured environment. Related art systems (e.g., Scan Context [4]) are known to suffer reduced performance outside of urban environments.

FIG. 14 illustrates plane detection using voxelization on the first keyframe of the KITTI00 dataset with a voxel size of 2 m. Points that form a plane are colored based on their Voxel ID.

FIG. 15 illustrates comparisons of all merged planes and selected reference planes, at different voxel sizes.

FIG. 16 illustrates height encoding of a pixel on the reference plane with pixel resolution r. Points above the pixel is divided into m layers, with each layer being encoded as a ‘1’ if it contains any points and ‘0’ otherwise, leading to a binary string “1111010”. The pixel intensity “5” is the bit sum of the binary string.

FIG. 17 illustrates processes related to key point extraction. Portion (a) illustrates a reference plane for height-encode image generation, all points are projected to the reference plane. Portion (b) illustrates the generated height-encoded image, each pixel encoding the points distribution above it. Portion (c) illustrates a zoomed-in region of a white square in portion (b) and illustrates a process of detecting local maxima (white squares) in 5×5 windows (red squares) and key points are generated at the corresponding pixel locations. Portion (d) illustrates the extracted key points in the submap. Key points are represented by yellow squares. The red number within each yellow square denotes the pixel intensity. The right sub-figure shows the points distribution above an extracted key point and its corresponding binary string.

All patents, patent applications, provisional applications, and publications referred to or cited herein are incorporated by reference in their entirety, including all figures and tables, to the extent they are not inconsistent with the explicit teachings of this specification.

The transitional term “comprising,” “comprises,” or “comprise” is inclusive or open-ended and does not exclude additional, unrecited elements or method steps. By contrast, the transitional phrase “consisting of” excludes any element, step, or ingredient not specified in the claim. The phrases “consisting” or “consists essentially of” indicate that the claim encompasses embodiments containing the specified materials or steps and those that do not materially affect the basic and novel characteristic(s) of the claim. Use of the term “comprising” contemplates other embodiments that “consist” or “consisting essentially of” the recited component(s).

When ranges are used herein, such as for dose ranges, combinations and subcombinations of ranges (e.g., subranges within the disclosed range), specific embodiments therein are intended to be explicitly included. When the term “about” is used herein, in conjunction with a numerical value, it is understood that the value can be in a range of 95% of the value to 105% of the value, i.e., the value can be +/−5% of the stated value. For example, “about 1 kg” means from 0.95 kg to 1.05 kg.

The methods and processes described herein can be embodied as code and/or data. The software code and data described herein can be stored on one or more machine-readable media (e.g., computer-readable media), which may include any device or medium that can store code and/or data for use by a computer system. When a computer system and/or processor reads and executes the code and/or data stored on a computer-readable medium, the computer system and/or processor performs the methods and processes embodied as data structures and code stored within the computer-readable storage medium.

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that are capable of storing computer-readable information/data. Computer-readable media should not be construed or interpreted to include any propagating signals. A computer-readable medium of embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Exemplified Embodiments

Embodiment 1. A key point extraction method, the method comprising the following steps:
taking in one or more point clouds;
for each respective point cloud, extracting a set of planes contained in the point cloud;
for each respective plane, identifying a set of boundaries;
for each respective boundary, identifying a set of nearby points and projecting each nearby point to the respective plane, to form a set of projected nearby points;
for each respective plane, constructing an image by mapping the set of projected nearby points to a set of pixels; and
for each respective image, extracting one or more salient pixels from the image as one or more key points.

Embodiment 2. The method of Embodiment 1, wherein the steps of extracting the set of planes and identifying the set of boundaries each, respectively, comprise a step of region growing.

Embodiment 3. The method of Embodiment 1, comprising the step of attaching to each pixel a local descriptor extracted from a set of pixel neighboring points.

Embodiment 4. The method of Embodiment 3, wherein the set of pixel neighboring points are points contained in a certain height of a space defined above the pixel.

Embodiment 5. An apparatus for providing a place recognition, the apparatus comprising:
a processor; and
a machine-readable medium in operable communication with the processor and having instructions stored thereon that, when executed by the processor, perform the following steps:
taking in a first point cloud and a second point cloud;
extracting three or more key points from within each respective point cloud;
forming one or more triangles from the extracted key points in each respective point cloud, each triangle having three side lengths, three included angles, optionally one or more values of derived information, and optionally one or more local descriptors;
for each respective triangle in either the first or second point cloud, constructing a stable triangle descriptor (STD) containing one or more elements selected from the group containing the side lengths, the included angles, the derived information, and the local descriptors, each respectively from the respective triangle; and
identifying if each STD in the first point cloud is similar to an STD in the second point cloud;
detecting if the first and second point clouds are taken in the same scene based on the number or ratio of similar STDs identified across the first and second point clouds, thereby providing the place recognition.

Embodiment 6. The apparatus of Embodiment 5, wherein each respective triangle is formed in a standard form wherein the side lengths, or included angles, or a mix of them, are arranged in a predetermined order.

Embodiment 7. The apparatus of Embodiment 6, wherein the instructions, when executed by the processor, perform the following additional step:
computing a relative pose between the first point cloud and the second point cloud based on point correspondence for one or more pairs of similar descriptors in different point clouds.

Embodiment 8. The apparatus of Embodiment 6, wherein the instructions, when executed by the processor, perform the following additional steps:
saving one or more STDs in the first point cloud to a library; and
querying in the library to retrieve one or more STDs that are similar to an STD in the second point cloud.

Embodiment 9. The apparatus of Embodiment 8, wherein the library is implemented as an array, a Hash table, or a K-Dimensional tree, which supports fast inquiry.

Embodiment 10. The apparatus of Embodiment 5, wherein the instructions, when executed by the processor, perform the following additional steps:
extracting a set of planes contained in the first point cloud; and
for each respective plane, identifying a set of boundaries;
and wherein the step of extracting three or more key points from within each respective point cloud comprises extracting one or more key points from a boundary.

Embodiment 11. The apparatus of Embodiment 10, wherein the instructions, when executed by the processor, perform the following additional steps:
defining a plane normal for each extracted plane; and
attaching each key point to a plane normal;
and wherein each STD constructed for each respective triangle in either the first or second point cloud includes an angle between plane normals of any two points of the respective triangle.

Embodiment 12. A key point extraction method, that:
takes in one or more point clouds;
extracts one or more planes contained in each respective point cloud and identifies one or more boundaries of each respective plane, if such boundaries of each respective plane are present in the respective point cloud;
projects one or more points near each respective boundary to the respective plane and constructs a respective image based on the one or more projected points; and
extracts one or more salient pixels from each respective image as key points.

Embodiment 13. The method of Embodiment 12, wherein the planes are extracted and the boundaries are identified by region growing.

Embodiment 14. The method of Embodiment 12, wherein each respective image pixel is attached with a local descriptor extracted from neighboring points of the respective pixel.

Embodiment 15. The method of Embodiment 14, wherein the local descriptor is constructed from points contained in a certain height of the space in a region above the pixel.

Embodiment 16. A place recognition apparatus, that:
takes in two or more point cloud;
extracts key points from each point cloud;
forms triangles from the key points and for each respective triangle constructs a descriptor containing the triangle side lengths, and/or included angles, and/or their derived information, and/or any local descriptors available; and
detects if the input point clouds are taken in the same scene based on the number or ratio of similar descriptors across them.

Embodiment 17. The apparatus of Embodiment 16, wherein each respective triangle takes a standard form where the triangle side lengths, or included angles, or a mix of them, are arranged in a determined order.

Embodiment 18. The apparatus of Embodiment 17, wherein comparing descriptors from different point clouds, if determined to be similar, gives the triangle vertices as point correspondences, which are then used to compute a relative pose between the two or more point clouds.

Embodiment 19. The apparatus of Embodiment 17, wherein descriptors of a first point cloud are saved to a library and a descriptor of a second point cloud is inquired in the library to retrieve similar descriptors.

Embodiment 20. The apparatus of Embodiment 19, wherein the library is implemented as an array, a Hash table, or a K-Dimensional tree, which supports fast inquiry.

Embodiment 21. The apparatus of Embodiment 16, wherein key points are extracted on the boundary of any plane in the point cloud.

Embodiment 22. The apparatus of Embodiment 21, wherein each respective key point is attached with a respective plane normal, and angles between respective plane normals of any two points of the triangle are also included in the descriptor.

Embodiment 23. A system for providing a place recognition, the system comprising: a processor; and a machine-readable medium in operable communication with the processor and having instructions stored thereon that, when executed by the processor, perform the following steps:
(a) receiving a first point cloud comprising a first plurality of points;
(b) producing a first plurality of descriptors from the first point cloud;
(c) receiving a second point cloud comprising a second plurality of points;
(d) producing a second plurality of descriptors from the second point cloud;
(e) comparing the first plurality of descriptors to the second plurality of descriptors to produce a comparison result;
(f) evaluating the comparison result to detect if the first point cloud and the second point cloud represent the same scene; and
(g) reporting if the first point cloud and the second point cloud represent the same scene, thus providing the place recognition;
wherein each of step (b) and step (d), respectively, comprises the following sub-steps:
(i) extracting a multiplicity of key points from the point cloud;
(ii) forming a multiplicity of triangles from the multiplicity of key points, each triangle comprising three vertices, three side lengths, three included angles, optionally one or more derived data fields, and optionally one or more local descriptors; and
(iii) constructing a stable triangle descriptor for each triangle, each respective stable triangle descriptor comprising at least one element selected from the list consisting of: a vertex of the triangle, a side length of the triangle, an included angle of the triangle, a data value derived from one or more physical properties or metadata values associated with the triangle, and a local descriptor associated with the triangle.

Embodiment 24. The system of Embodiment 23, wherein each respective triangle is stored in a triangle data structure having a standard form where two or more of the triangle side lengths, or included angles, or a mix of them, are arranged in a specified order.

Embodiment 25. The apparatus of Embodiment 24, wherein the comparison result comprises an indicator of similarity or non-similarity between each respective stable triangle descriptor in the first plurality of stable triangle descriptors with respect to at least one stable triangle descriptor in the second plurality of stable triangle descriptors.

Embodiment 26. The apparatus of Embodiment 25, wherein the instructions, when executed by the processor, perform the following step:
(h) computing a relative pose between the first point cloud and the second point cloud, the computing based on one or more first triangle vertices from a first triangle formed from the first point cloud and one or more second triangle vertices from a second triangle formed from the second point cloud, wherein the stable triangle descriptor of the first triangle is similar to the stable triangle descriptor of the second triangle.

Embodiment 27. The apparatus of Embodiment 24, wherein the descriptors of the first point cloud are saved to a library and one or more of the descriptors of the second point cloud are queried against the library to retrieve similar descriptors.

Embodiment 28. The apparatus of Embodiment 26, wherein the library is implemented as an array, a Hash table, or a K-Dimensional tree, which supports fast inquiry.

Embodiment 29. The apparatus of Embodiment 23, wherein the key points are extracted on a boundary of a plane, the plane defined by a set of points in the respective point cloud.

Embodiment 30. The apparatus of Embodiment 29, wherein each key point is attached with a plane normal of the plane from which that key point was extracted, and an angle between respective plane normals of any two points of the triangle are also included in each stable triangle descriptor.

Embodiment 31. A key point extraction method, that:
takes in a point cloud;
extracts a multiplicity of planes contained in the point cloud and identifies a set of boundaries related to each plane;
projects a set of points near each boundary to the related plane to construct an image based on the respective set of projected points; and
extracts a set of salient pixels from each respective image to form a set of key points.

Embodiment 32. The method of Embodiment 31, wherein each plane and each respective set of boundaries related to each plane are extracted by region growing.

Embodiment 33. The method of Embodiment 31, wherein each pixel of each image is associated with a local descriptor extracted from the points neighboring the pixel.

Embodiment 34. The method of Embodiment 33, wherein the local descriptor is constructed from points contained in a specified height of a space above the pixel.

Embodiment 35. A system for providing a place recognition, the system comprising:
a processor; and
a machine-readable medium in operable communication with the processor and having instructions stored thereon that, when executed by the processor, perform the following steps:
taking in at least two point clouds;
extracting a multiplicity of key points from each point cloud;
forming a set of triangles from the multiplicity of key points from each point cloud;
constructing a stable triangle descriptor for each triangle, each stable triangle descriptor comprising at least one of:
   a side length of the triangle,
   an included angle of the triangle,
   a data value derived from the side length or the included angle or both, and
   a local descriptor associated with the triangle; and
detecting if the two point clouds are taken in the same scene based on a number or a ratio of similar stable triangle descriptors across the two point clouds, thereby providing the place recognition.

Embodiment 36. The system of Embodiment 35, wherein each triangle is stored in a standard form wherein the triangle side lengths, the triangle included angles, or a mix of the triangle side lengths and the triangle included angles, are arranged in a predetermined order.

Embodiment 37. The system of Embodiment 36, wherein the two point clouds are a first point cloud and a second point cloud, and wherein the instructions, when executed by the processor, perform the following steps:
computing a relative pose of the second point cloud with respect to the first point cloud;
wherein the relative pose is computed based on a comparison between the triangle vertices of a first triangle associated with the first point cloud and the triangle vertices of a second triangle associated with the second point cloud; and
wherein the stable triangle descriptor of the first triangle and the stable triangle descriptor of the second triangle are similar.

Embodiment 38. The system of Embodiment 36, wherein the two point clouds are a first point cloud and a second point cloud, and wherein the instructions, when executed by the processor, perform the following steps:
saving each descriptor of the first point cloud to a library; and
querying each descriptor of the second point cloud within the library to retrieve similar descriptors.

Embodiment 39. The system of Embodiment 38, wherein the library is implemented as an array, a Hash table, or a K-Dimensional tree, configured and adapted to support fast querying.

Embodiment 40. The system of Embodiment 35, wherein the key points are extracted based on proximity to one or more boundaries of one or more planes in one of the two point clouds.

Embodiment 41. The system of Embodiment 40, wherein the two point clouds are a first point cloud and a second point cloud, and wherein the instructions, when executed by the processor, perform the following steps:
attaching a normal of the associated plane to each key point; and
including an angle between normals of any two points of each triangle in the stable triangle descriptor.

Embodiment 42. A key point extraction method, the method comprising the following steps:
accessing a point cloud;
extracting a plane contained in the point cloud;
finding a boundary of the plane;
identifying a set of points near the boundary;
projecting each point in the set of points onto the plane;
constructing a planar image based on the projected points, the image comprising a multiplicity of pixels; and
extracting salient pixels from the multiplicity of pixels to produce a set of key points.

Embodiment 43. The method of Embodiment 42, wherein the step of extracting the plane and the step of finding the boundary, respectively, each comprises a process of region growing.

Embodiment 44. The method of Embodiment 42, wherein the step of extracting salient pixels comprises attaching a local descriptor to each pixel of the multiplicity of pixels, wherein each respective local descriptor comprises data extracted from one or more points neighboring the respective pixel.

Embodiment 45. The method of Embodiment 44, wherein each respective local descriptor is constructed from points contained in a defined space at a specified height above the pixel.

Embodiment 46. A key point extraction method, comprising:
accessing a point cloud;
extracting a multiplicity of planes contained in the point cloud;
generating one or more reference planes from the multiplicity of planes;
projecting the point cloud onto each of the one or more reference planes to create one or more images; and
extracting a set of salient pixels from each of the one or more images to form a set of key points.

Embodiment 47. The method of Embodiment 46, wherein the extracting a multiplicity of planes contained in the point cloud comprises region growing.

Embodiment 48. The method of Embodiment 46, wherein the generating one or more reference planes from the multiplicity of planes comprises:
merging adjacent planes from the multiplicity of planes;
sorting merged planes in descending order according to a number of contained points; and
selecting one or more planes with the most points as the one or more reference planes.

Embodiment 49. The method of Embodiment 46, wherein each pixel of each image is associated with a local descriptor extracted from the points neighboring the pixel.

Embodiment 50. The method of Embodiment 49, wherein the local descriptor is constructed from points contained in a specified height of a space above the pixel.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

[1] B. Steder, G. Grisetti, and W. Burgard, “Robust place recognition for 3d range data based on point features,” in 2010 IEEE International Conference on Robotics and Automation, 2010, pp. 1400-1405
[2] M. Bosse and R. Zlot, “Place recognition using keypoint voting in large 3d lidar datasets,” in 2013 IEEE International Conference on Robotics and Automation, 2013, pp. 2677-2684
[3] M. Magnusson, H. Andreasson, A. N üchter, and A. J. Lilienthal, “Automatic appearance-based loop detection from three-dimensional laser data using the normal distributions transform,” Journal of Field Robotics, vol. 26, no. 11-12, pp. 892-914, 2009.
[4] G. Kim and A. Kim, “Scan context: Egocentric spatial descriptor for place recognition within 3d point cloud map,” in 2018 IEEE/RSJ International Conference on Intelligent Robots and Systems (IROS). IEEE, 2018, pp. 4802-4809.
[5] Nardari G V, Cohen A, Chen S W, et al. Place Recognition in Forests With Urquhart Tessellations[J]. IEEE Robotics and Automation Letters, 2020, 6(2): 279-286.
[6] R. Dub'e, D. Dugas, E. Stumm, J. Nieto, R. Siegwart, and C. Cadena, “Segmatch: Segment based place recognition in 3d point clouds,” in 2017 IEEE International Conference on Robotics and Automation (ICRA). IEEE, 2017, pp. 5266-5272
[7] X. Chen, T. Läbe, A. Milioto, T. Röhling, O. Vysotska, A. Haag, J. Behley, and C. Stachniss, “OverlapNet: Loop Closing for LiDAR-based SLAM,” in Proceedings of Robotics: Science and Systems (RSS), 2020
[8] Liu Y, Shunbo Z, Liu Z, et al. Systems and methods for place recognition based on 3D point cloud: U.S. Pat. No. 11,182,612[P]. 2021-11-23.
[9] W. Xu, Y. Cai, D. He, J. Lin and F. Zhang, “FAST-LIO2: Fast Direct LiDAR-Inertial Odometry,” in IEEE Transactions on Robotics, doi: 10.1109/TRO.2022.3141876.
[10] Sipiran I, Bustos B. “Harris 3D: a robust extension of the Harris operator for interest point detection on 3D meshes,” in The Visual Computer, 2011, 27(11): 963-976.
[11] Derpanis K G. “Overview of the RANSAC Algorithm,” in Image Rochester NY, 2010, 4(1): 2-3.

1. A key point extraction method comprising the steps of:
taking in one or more point clouds;
extracting one or more planes contained in each respective point cloud;
identifying one or more boundaries of each respective plane, if such boundaries of each respective plane are present in the respective point cloud;
identifying one or more nearby points and projecting one or more points near each respective boundary to the respective plane, to form a set of projected nearby points;
constructing an image based on the one or more projected points by mapping the set of projected nearby points to a set of pixels; and
extracting one or more salient pixels from each respective image as one or more key points.

2. The method of claim 1, wherein the steps of extracting the one or more planes and identifying the one or more boundaries each, respectively, comprise a step of region growing.

3. The method of claim 1, further comprising the step of attaching to each pixel a local descriptor extracted from a set of pixel neighboring points.

4. The method of claim 3, wherein the set of pixel neighboring points are points contained in a certain height of a space defined above the pixel.

5. An apparatus for providing a place recognition comprising:
a processor; and
a machine-readable medium in operable communication with the processor and having instructions stored thereon that, when executed by the processor, perform the following steps:
taking in a first point cloud and a second point cloud;
extracting three or more key points from within each respective point cloud;
forming one or more triangles from the extracted key points in each respective point cloud, each triangle having three side lengths, three included angles, optionally one or more values of derived information, and optionally one or more local descriptors;
for each respective triangle in either the first or second point cloud, constructing a stable triangle descriptor (STD) containing one or more elements selected from the group containing the side lengths, the included angles, the derived information, and the local descriptors, each respectively from the respective triangle; and
identifying if each STD in the first point cloud is similar to an STD in the second point cloud;
detecting if the first and second point clouds are taken in the same scene based on the number or ratio of similar STDs identified across the first and second point clouds, thereby providing the place recognition.

6. The apparatus of claim 5, wherein each respective triangle is formed in a standard form wherein the side lengths, or included angles, or a mix of them, are arranged in a predetermined order.

7. The apparatus of claim 6, wherein the instructions, when executed by the processor, perform the following additional step:
computing a relative pose between the first point cloud and the second point cloud based on point based on comparing descriptors from different point clouds to determine correspondence for one or more pairs of similar descriptors in different point clouds.

8. The apparatus of claim 6, wherein the instructions, when executed by the processor, perform the following additional steps:
saving one or more STDs in the first point cloud to a library; and
querying in the library to retrieve one or more STDs that are similar to an STD in the second point cloud.

9. The apparatus of claim 8, wherein the library is implemented as an array, a Hash table, or a K-Dimensional tree, which supports fast inquiry.

10. The apparatus of claim 5, wherein the instructions, when executed by the processor, perform the following additional steps:
extracting a set of planes contained in the first point cloud; and
for each respective plane, identifying a set of boundaries;
and wherein the step of extracting three or more key points from within each respective point cloud comprises extracting one or more key points from a boundary.

11. The apparatus of claim 10, wherein the instructions, when executed by the processor, perform the following additional steps:
defining a plane normal for each extracted plane; and
attaching each key point to a plane normal;
and wherein each STD constructed for each respective triangle in either the first or second point cloud includes an angle between plane normals of any two points of the respective triangle.

12-20. (canceled)

21. The apparatus of claim 5, wherein key points are extracted on the boundary of any plane in each respective point cloud.

22. The apparatus of claim 21, wherein each respective key point is attached with a respective plane normal, and angles between respective plane normals attached with any two points of the triangle are also included in the descriptor.

23. A system for providing a place recognition, the system comprising:
a processor; and
a machine-readable medium in operable communication with the processor and having instructions stored thereon that, when executed by the processor, perform the following steps:
(a) receiving a first point cloud comprising a first plurality of points;
(b) producing a first plurality of descriptors from the first point cloud;
(c) receiving a second point cloud comprising a second plurality of points;
(d) producing a second plurality of descriptors from the second point cloud;
(e) comparing the first plurality of descriptors to the second plurality of descriptors to produce a comparison result;
(f) evaluating the comparison result to detect if the first point cloud and the second point cloud represent the same scene; and
(g) reporting if the first point cloud and the second point cloud represent the same scene, thus providing the place recognition;
wherein each of step (b) and step (d), respectively, comprises the following sub-steps:
(i) extracting a multiplicity of key points from the point cloud;
(ii) forming a multiplicity of triangles from the multiplicity of key points, each triangle comprising three vertices, three side lengths, three included angles, optionally one or more derived data fields, and optionally one or more local descriptors; and
(iii) constructing a stable triangle descriptor for each triangle, each respective stable triangle descriptor comprising at least one element selected from the list consisting of: a vertex of the triangle, a side length of the triangle, an included angle of the triangle, a data value derived from one or more physical properties or metadata values associated with the triangle, and a local descriptor associated with the triangle.

24. (canceled)

25. The apparatus of claim 5, wherein the comparison result comprises an indicator of similarity or non-similarity between each respective stable triangle descriptor in the first plurality of stable triangle descriptors with respect to at least one stable triangle descriptor in the second plurality of stable triangle descriptors.

26. The system of claim 25, wherein the instructions, when executed by the processor, perform the following step:
(h) computing a relative pose between the first point cloud and the second point cloud, the computing based on one or more first triangle vertices from a first triangle formed from the first point cloud and one or more second triangle vertices from a second triangle formed from the second point cloud, wherein the stable triangle descriptor of the first triangle is similar to the stable triangle descriptor of the second triangle.

27-36. (canceled)

37. The system of claim 23, the instructions, when executed by the processor, perform the following steps:
computing a relative pose of the second point cloud with respect to the first point cloud;
wherein the relative pose is computed based on a comparison between the triangle vertices of a first triangle associated with the first point cloud and the triangle vertices of a second triangle associated with the second point cloud; and
wherein the stable triangle descriptor of the first triangle and the stable triangle descriptor of the second triangle are similar.

38-39. (canceled)

40. The system of claim 23, wherein the key points are extracted based on proximity to one or more boundaries of one or more planes in one of the two point clouds.

41-45. (canceled)

46. A key point extraction method, comprising:
accessing a point cloud;
extracting a multiplicity of planes contained in the point cloud;
generating one or more reference planes from the multiplicity of planes;
projecting the point cloud onto each of the one or more reference planes to create one or more images; and
extracting a set of salient pixels from each of the one or more images to form a set of key points.

47. (canceled)

48. The method of claim 46, wherein the generating one or more reference planes from the multiplicity of planes comprises:
merging adjacent planes from the multiplicity of planes;
sorting merged planes in descending order according to a number of contained points; and
selecting one or more planes with the most points as the one or more reference planes.

49-50. (canceled)
